(19) United States
(12) Patent Application Publication
(10) Pub. No.: US 2007/0217332 A1
(43) Pub. Date: Sep. 20, 2007

(54) Communication method, apparatus, system and computer program

(75) Inventor: Masanori Nakahara, Chigasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/711,709

(22) Filed: Feb. 28, 2007

(30) Foreign Application Priority Data
Mar. 7, 2006 (JP) 2006-061227

(51) Int. Cl. H04L 12/26; G08B 29/00; G08B 19/00; G06F 3/12

(52) U.S. Cl. 370/229; 340/506; 340/521; 358/1.15

(57) ABSTRACT

A communication system for making communication devices on a network separately transmit annunciation signals, said system comprising a control unit for controlling proportion of transmission of the annunciation signals of each communication device based upon device information of at least two communication devices. This makes it possible to control transmission that the power consumption signal in such a manner that the power consumption of the overall system is optimized.

### BACKGROUND OF THE INVENTION

1. Field of the Invention

The present invention relates to a communication method, communication device and communication system for controlling an annunciation signal and to a computer program for causing a computer to execute the communication method.

2. Description of the Related Art

A large number of devices equipped with a wireless function such as an IEEE 802.11 wireless LAN or Bluetooth have become commercially available and utilized in recent years. Since such a wireless device generally has a high degree of portability, many of these devices are driven by a battery. Reducing power consumption, therefore, in a major challenge.

Generally, when a network is formed using wireless communication, there is an infrastructure mode in which terminals communicate with a base station, and an ad-hoc mode in which terminals communicate with one another directly.

In the ad-hoc mode of an IEEE 802.11 wireless LAN, terminals constituting the network manage information for network construction in a decentralized manner. More specifically, any one of the terminals constituting the network transmits an annunciation signal (beacon) at certain fixed time intervals.

Further, it is necessary that the terminal that transmitted the annunciation signal operates in the normal mode until the next annunciation signal is transmitted. In the interim, the terminal cannot be placed in a power saving mode even if no data is sent or received.

Thus, in the ad-hoc mode, it is required that each of the terminals engage in role sharing. Consequently, which terminal performs its role is important from the standpoint of power consumption.

A technique whereby a wireless terminal performs communication control so as to reduce power consumption in accordance with the remaining amount of battery capacity at its own terminal has been proposed heretofore (e.g., see the specifications of Japanese Patent Application Laid-Open Nos. 9-135254 and 10-209953). In this conventional technique, control for conservation of power is performed based solely upon the terminal's own information. However, in the case of a system in which information for network construction is managed by each of the terminals in a decentralized manner, as in the ad-hoc mode of the IEEE 802.11 wireless LAN, there are instances where even though the terminal's own power consumption can be reduced, the burden upon another terminal increases correspondingly. As a result, a case where power consumption cannot be reduced appropriately over the entire system is conceivable.

### SUMMARY OF THE INVENTION

The present invention controls the power consumption of a communication device upon referring to information concerning other communication devices constituting a network.

One aspect of the present invention provides a communication method of a communication device which separately transmits annunciation signals in conjunction with other communication devices on a network, comprising a control step of controlling a proportion of the annunciation signal that the communication device and the other communication devices based upon device information of the other communication devices.

The other aspect of the present invention provides a communication device which is connected with other communication devices through a network and separately transmits annunciation signals in conjunction with the other communication devices, the apparatus comprising a discrimination unit for discriminating an apparatus for which frequency of transmission of the annunciation signal will be changed, based upon the device information of the other communication devices, wherein proportion of transmission of the annunciation signal of each communication device on the network is controlled by changing frequency of transmission of the annunciation signal of the apparatus discriminated by the discrimination means.

The far other aspect of the present invention provides a communication system for making communication devices on a network separately transmit annunciation signals, the system comprising a control unit for controlling proportion of transmission of the annunciation signals of each communication device based upon device information of at least two communication devices.

Further features of the present invention will become apparent from the following description of exemplary embodiments (with reference to the attached drawings).

### BRIEF DESCRIPTION OF THE DRAWINGS

FIG. 1 is a diagram illustrating the configuration of a network in an embodiment of the present invention;

FIG. 2 is a functional block diagram of a digital still camera;

FIG. 3 is a functional block diagram of a printer;

FIG. 4 is a sequence diagram of a processing sequence in a first embodiment;

FIG. 5 is a flowchart illustrating operation of a digital still camera according to the first embodiment;

FIG. 6 is a flowchart illustrating operation of a digital still camera and printer according to the first embodiment;

FIG. 7 is a sequence diagram of a processing sequence in a second embodiment;

FIG. 8 is a flowchart illustrating operation of a digital still camera according to the second embodiment;

FIG. 9 is a flowchart illustrating operation of a digital still camera and printer according to the second embodiment;

FIG. 10 is a flowchart illustrating operation of a terminal that starts processing for gathering device information in a third embodiment; and

FIG. 11 is a flowchart illustrating operation of a terminal that receives a device-information inquiry in the third embodiment.

### DESCRIPTION OF THE EMBODIMENTS

Preferred embodiments of the present invention will be described in detail with reference to the drawings. It should be noted that the present invention is not limited to the embodiment and can be modified in various ways within the scope of the claims.

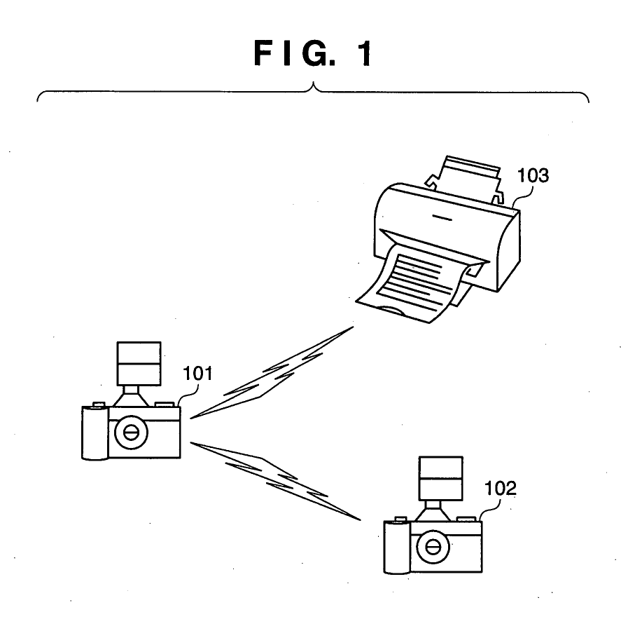

FIG. 1 is a diagram illustrating an example of the configuration of a wireless communication network in an embodiment of the present invention. Digital cameras 101, 102 and a printer 103 each have a wireless communication function based upon a wireless LAN. The digital cameras are capable of performing data communication wirelessly with each other and with the printer. The communication mode in which terminals thus communicate directly with each other without the intermediary of a base station is referred to as the ad-hoc mode.

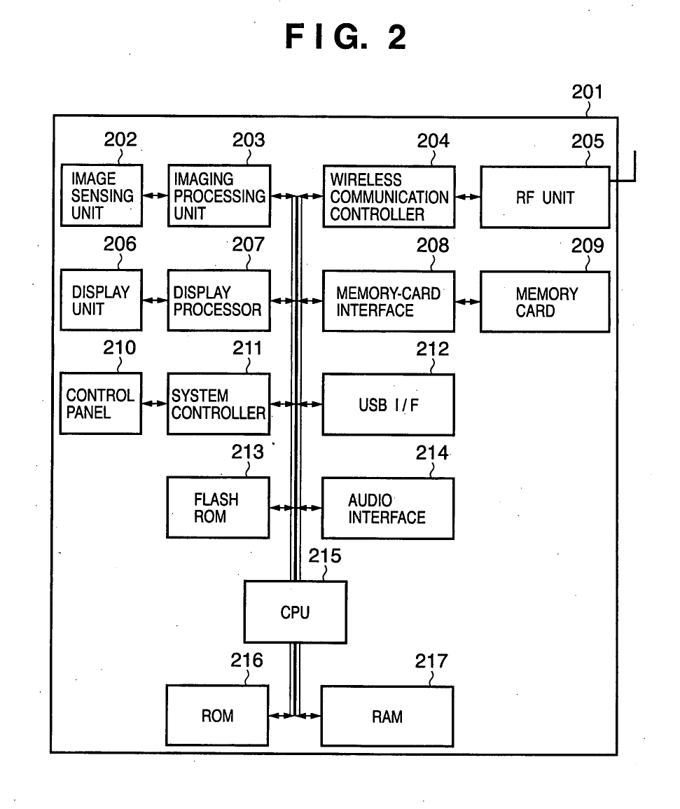

FIG. 2 is a functional block diagram of the digital cameras 101, 102.

A control panel 210 is connected to a CPU 215 via a system controller 211 and includes a shutter-release switch, etc., of the digital camera.

An image sensing unit 202 is a block for sensing an image when the shutter-release switch is pressed. The image is processed by an imaging processing unit 203.

A display unit 206 is a block for presenting information to the user and is an LCD, LED display or voice display, etc. Processing for controlling the content of the display is executed by a display processor 207.

Further, operation such as the selection of information displayed by the display unit 206 is carried out via the control panel 210.

A memory-card interface 208 is an interface for connecting a memory card 209. A USB interface 212 is an interface for connecting an external device using a USB. An audio interface 214 is an interface for connecting an audio signal to an external device.

A wireless communication RF unit 205 and a wireless communication controller 204 are combined to construct a wireless unit. The wireless communication RF unit 205 includes a hardware block for digitizing an analog signal received from an antenna and, conversely, for converting digital information to an analog signal and transmitting the signal from the antenna. The wireless communication controller 204 is constituted by a MAC layer that controls communication and hardware for processing firmware that drives the MAC layer. The wireless communication controller 204 has an internal flash ROM that is capable of storing a MAC address, etc.

The functional portions indicated in this block diagram are implemented by control exercised by the CPU 215. An operating program, described later, has been stored in a ROM 216 or flash ROM 213 or memory card 209, and the CPU 215 executes processing in accordance with this program.

Further, data to be processed by the CPU 215 is written to and read from a RAM 217 or the flash ROM 213 or the memory card 209. Image data resulting from imaging is stored on the memory card 209.

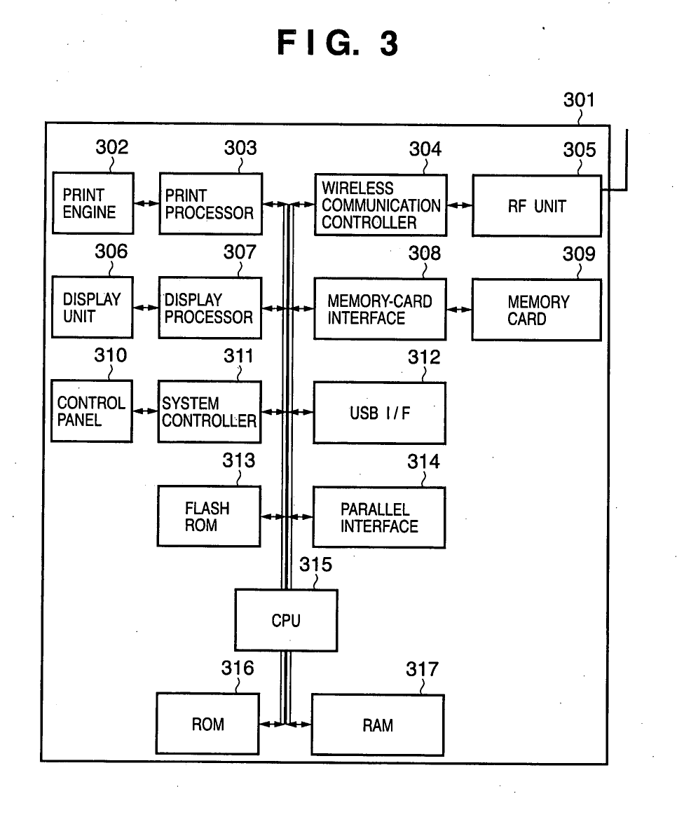

FIG. 3 is a functional block of the printer 103.

A control panel 310 is connected to a CPU 315 via a system controller 311.

A print engine 302, which is a functional block for actually printing an image on paper, is controlled by a print processor 303.

A display unit 306 is a block for presenting information to the user and is an LCD, LED display or voice display, etc. Control of the content of the display presented by the display unit 306 is performed by a display processor 307. Further, operation such as the selection of information displayed by the display unit 306 is carried out via the control panel 310.

A memory-card interface 308 is an interface for connecting a removable memory card 309. A USB interface 312 is an interface for connecting an external device using a USB. A parallel interface 314 is an interface for connecting an external device using parallel communication.

A wireless communication RF unit 305 and a wireless communication controller 304 are combined to construct a wireless unit. The wireless communication RF unit 305 includes a hardware block for digitizing an analog signal received from an antenna and, conversely, for converting digital information to an analog signal and transmitting the signal from the antenna. The wireless communication controller 304 is constituted by a MAC layer that controls communication and hardware for processing firmware that drives the MAC layer. The wireless communication controller 304 has an internal flash ROM that is capable of storing a MAC address, etc.

The functional portions indicated in this block diagram are implemented by control exercised by the CPU 315. An operating program, described later, has been stored in a ROM 316 or flash ROM 313, and the CPU 315 executes processing in accordance with this program.

Data to be processed by the CPU 315 is written to and read from a RAM 317 or the flash ROM 313 or the memory card 309.

The structures of the digital cameras 101, 102 and printer 103 in this embodiment have been described.

A transmission algorithm for transmitting a annunciation signal in the ad-hoc mode compliant with the IEEE 802.11 standard will be described using the digital camera 101.

Transmission of the annunciation signal in the ad-hoc mode is performed autonomously and in decentralized fashion among all terminals that construct the network. The transmission interval of the annunciation signal is decided by the terminal that first constructed the ad-hoc mode. Normally the annunciation signal is transmitted from any terminal at intervals of 100 ms.

The timing at which the annunciation signal is transmitted is controlled by a variable referred to as a “contention window” (a range of randomly generated numbers) (the contention window shall be referred to as “CW” below). When timing at which the annunciation signal is to be transmitted arrives, the wireless unit of the digital camera 101 obtains a certain random value (CWrand) from a range of from 0 to CWmax (the maximum value of CW). Next, the wireless unit decrements CWrand at predetermined fixed intervals (slot times) and transmits the annunciation signal when CWrand becomes 0.

If an annunciation signal is received from another terminal (digital camera 102 or printer 103) before the wireless unit of the digital camera 101 itself transmits the annunciation signal, the wireless unit of the digital camera 101 suspends processing for transmitting the annunciation signal.

The terminals in the ad-hoc network execute the above-described algorithm in unison at the timing of transmission of the annunciation signal. Each terminal selects a random number between 0 and CWmax. Among the terminals that construct the network, the terminal that has selected the smallest CWrand transmits the annunciation signal.

For example, if the digital camera 101 has selected the smallest CWrand and transmitted the annunciation signal, then the digital camera 102 and printer 103 suspend annunciation signal transmission processing in mid-course.

Further, if the same CWmax has been set in each terminal, then each of the terminals will share equally in the transmission of the annunciation signal.

Thus, regardless of whether image data to be sent and received exists, it is required that the wireless unit of each terminal participates in control for transmitting the annunciation signal so long as these terminals are participating in the ad-hoc network.

Further, the terminal that has transmitted the annunciation signal is required to operate in the normal mode and not shift to a power saving mode until the next timing at which the annunciation signal is to be transmitted. As a result, another terminal (a new digital camera, etc., not shown in FIG. 1) is capable of responding to a search signal (referred to as a “probe request”) transmitted when the terminal attempts to participate in the network. As a consequence, over this period of time, the terminal that transmits the annunciation signal consumes more power in comparison with the other terminals. It should be noted that the normal mode refers to a state in which supply of power to the wireless unit is ON at all times. The power saving mode refers to a state in which supply of power to the wireless unit is turned OFF for at least a fixed period of time.

By way of example, it is desired that a battery-driven terminal such as a digital camera consume less power than a terminal driven by an AC power source. Accordingly, described below will be several embodiments relating to processing for reducing power consumption of a terminal by diminishing the rate at which the terminal transmits the annunciation signal.

### First Embodiment

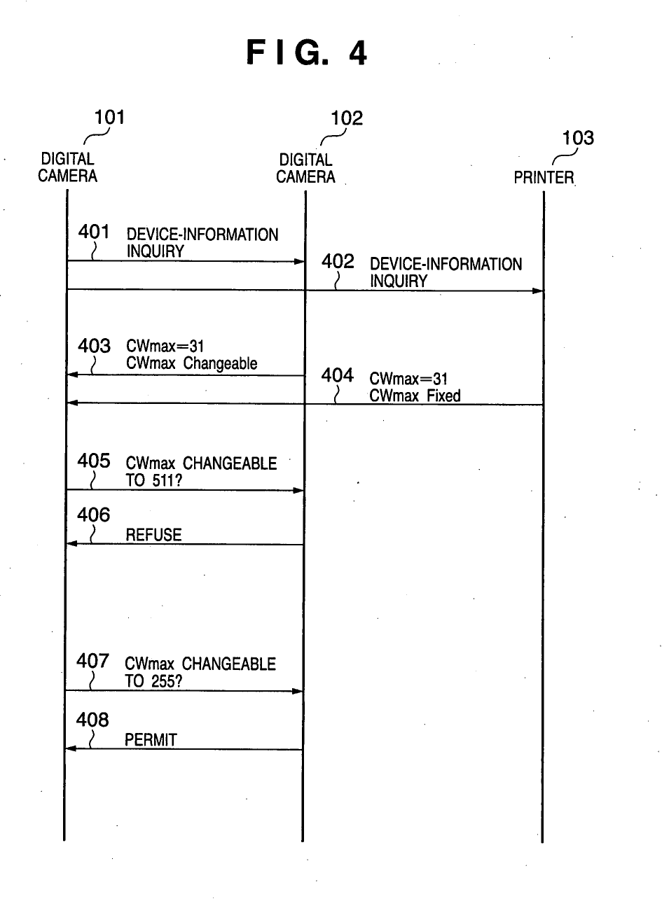

FIG. 4 is a diagram illustrating a sequence according to a first embodiment.

It will be assumed that the state prevailing before the sequence of FIG. 4 is executed is one in which the digital cameras 101, 102 and printer 103 already exist on the same network and know one another's communication identifiers (MAC addresses, etc.). In this embodiment, processing in a case where power consumption of the digital camera 101 is reduced will be described.

First, the digital camera 101 queries the digital camera 102 and printer 103 for device information (401, 402). Although the respective messages are transmitted by unicast in FIG. 4, unicast is not especially required and transmission may just as well be performed by broadcast or multicast. Here unicast refers to a method of transmitting data to a specific communication partner, broadcast refers to a method of transmitting data to an unspecified number of partners, and multicast refers to a method of transmitting data to a plurality of designated partners.

It should be noted that device information includes two items of information, namely the maximum value CWmax of CW and the capability to change CWmax. In order to change the rate of transmission of the annunciation signal, the wireless unit is equipped with a function for changing CWmax and CWmax must be changeable to a desired value using a program executed by CPUs 215, 315.

In this embodiment, it is assumed that the value of CWmax of digital camera 101 is 31 and that it is possible to change CWmax. Further, it is assumed that it is possible for digital camera 101 and digital camera 102 to change CWmax and that printer 103 cannot change CWmax.

Upon receiving the inquiry for device information, the digital camera 102 sends back information to the effect that CWmax is 31 and that CWmax is changeable (403). The printer 103 sends back information to the effect that CWmax similarly is 31 but that CWmax is fixed, i.e., is unchangeable (404).

The digital camera 101 determines whether it should change its own CWmax based upon the device information that has been transmitted from the digital camera 102 and printer 103. Here the digital camera 101 determines that CWmax should be changed to 511. The digital camera 101 then queries the digital camera 102, which is capable of changing CWmax, as to whether it is permissible to change CWmax to 511 (405).

Upon receiving this inquiry, the digital camera 102 determines whether to permit or refuse the changing of CWmax by the digital camera 101 and replies to this effect. For example, there is a determination method whereby the digital camera 102 refuses a change when CWmax has just been changed. The digital camera 102 sends back a change refusal at 406.

Upon receiving the change refusal, the digital camera 101 again determines whether to change its own CWmax. Here the digital camera 101 determines that CWmax should be changed to 255 and, in a manner similar to that at 405, queries the digital camera 102 as to whether the change is permitted (407).

Upon receiving the inquiry, the digital camera 102 determines whether to permit the change. If it permits the change, then the digital camera 102 notifies the digital camera 101 to this effect (408). By virtue of the foregoing processing, the digital camera 101 is capable of changing CWmax and sets the value 255 of CWmax in its wireless unit. As a result, the rate at which the digital camera 101 transmits the annunciation signal is reduced in comparison with the digital camera 102 and printer 103.

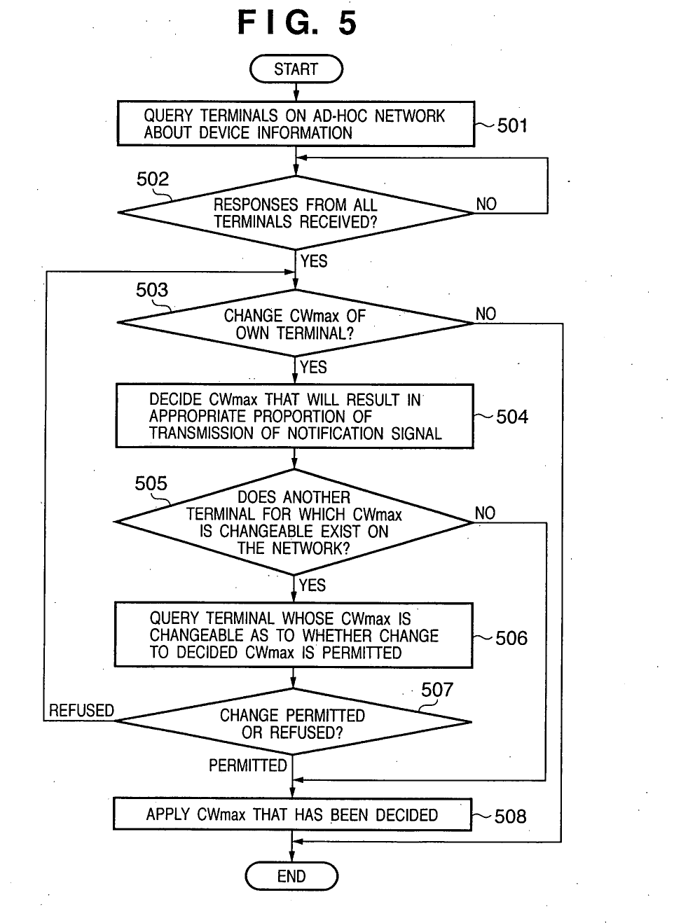

FIG. 5 illustrates the flow of operation of the digital camera 101.

First, the digital camera 101 transmits an inquiry for device information to terminals constituting an ad-hoc network (501). The digital camera 101 waits for responses from all devices on the network (562).

If device information including the value of CWmax and information indicating whether CWmax is changeable or not is received (“YES” at 502), then the digital camera 101 examines the received information and determines whether or not to change its own CWmax (503). For example, there is a method whereby the digital camera 101 changes CWmax if the value of CWmax of another terminal is more than twice its own CWmax, and a method whereby the digital camera 101 changes CWmax if its own CWmax is the smallest value.

If the digital camera 101 has determined to change its own CW, it decides such a CWmax that will enable it to transmit the annunciation signal at a rate that is appropriate in relation to the other terminals (504). For instance, in the example of FIG. 4, the CWmax of all three devices is 31. Under these circumstances, therefore, the three devices transmit the annunciation signal at equal probabilities.

If the CWmax of digital camera 101 becomes 255, then the digital camera 101 lowers the proportion of the number of times it transmits the annunciation signal to about ¼ in comparison with the digital camera 102 and printer 103. Further, by exercising control such that the power saving mode is established when the annunciation signal is not transmitted, a further reduction in power consumption can be achieved.

Next, the device information that was received at 502 is checked to determine whether another terminal that is capable of changing CWmax exists (505). If a terminal that is capable of changing CWmax exists, then the digital camera 101 inquires as to whether it is permissible to change CWmax to the decided value (506).

If permission to make the change is received (PERMITTED at 507), then the CWmax that has been decided is applied (508). If refusal to make the change is received (REFUSED at 507), control returns to 503 and the digital camera 101 again determines whether or not to change CWmax. It should be noted that now the digital camera 101 determines whether to change CWmax to a value smaller than the CWmax that was refused previously. For example, there is a method whereby even if CWmax is made smaller than the value refused earlier, CWmax is changed if it is more than twice the CWmax of another terminal.

In a case where permission to change CWmax is not obtained even if the processing of 503 to 506 is repeated a prescribed number of times or within a prescribed period of time, then the digital camera 101 determines that CWmax is not to be changed (“NO” at 503) and terminates processing. In this case, CWmax remains unchanged.

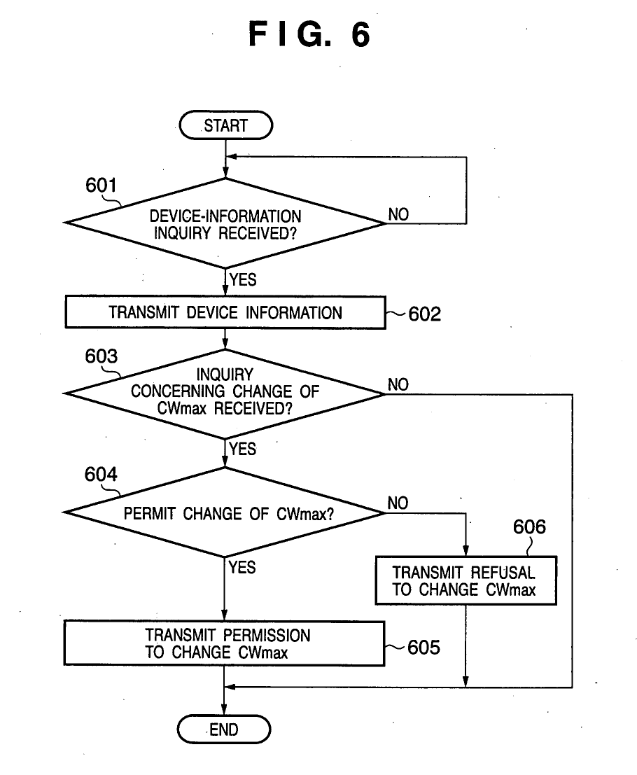

Next, the flow of operation of digital camera 102 and printer 103 will be described with reference to FIG. 6.

First, the digital camera 102 and printer 103 wait for receipt of an inquiry for device information (601). If the inquiry is received (“YES” at 601), the digital camera 102 or printer 103 transmits device information to the source of transmission of the inquiry (602).

If an inquiry as to whether it is permissible to change CWmax is subsequently received (“YES” at 603), then it is determined whether to permit the change of CWmax (604). As for criteria for making this determination, conceivable methods include a method of refusing a change if the digital camera 102 or printer 103 has already changed CWmax even one time, a method of refusing a change if CWmax of the communication partner will become larger than its own CWmax, and a method of refusing a change if CWmax of the communication partner will become larger than a prescribed value.

If the change is permitted (“YES” at 604), then permission for the change is transmitted (605). If the change is not permitted (“NO” at 604), then refusal of the change is transmitted (606) and processing is terminated. If an inquiry as to whether CWmax may be changed is not received (“NO” at 603), then processing is terminated as is.

In accordance with this embodiment, based upon device information acquired from another terminal, the value of CWmax of one's own terminal is changed in order to adjust the rate at which this terminal transmits the annunciation signal. Accordingly, power consumption of one's own terminal can be reduced upon taking into consideration the states of other terminals present on the same network.

This embodiment has been illustrated with regard to an example in which CWmax is changed to a large value in order to reduce the power consumption of one's own terminal. However, in a case where one's own terminal has extra power, CWmax may be changed to a small value in order to raise the rate at which the annunciation signal is transmitted from this terminal. For example, in a case where another terminal that does not have a surplus of power exists, transmitting the annunciation signal from one's own terminal more often can, as a result, reduce the power consumption of this other terminal.

Further, besides the value of CWmax and the information as to whether CWmax is changeable or not, the device information in the foregoing embodiment may include information as to whether power is being received from an AC power source or from a battery. In the case of the battery, it is also possible to include information indicating the remaining capacity of the battery. By using these items of information, it is possible to determine whether or not to change CWmax upon taking into account the power consumption of the overall system. For example, control can be exercised in such a manner that even if one's own terminal is powered by a battery and it is desired to reduce its power consumption, no change is made in the CWmax when another terminal is also powered by a battery and the remaining capacity of this battery is small.

Further, this embodiment is such that in a case where a terminal that has received an inquiry as to whether CWmax may be changed refuses the change, the terminal transmits refusal of the change. However, the refusal need not necessarily be transmitted. If the terminal that has transmitted the inquiry in such case does not receive permission for the change upon elapse of a prescribed period of time, the terminal determines the change to have been refused. Thus, the same effect can be obtained.

The operation illustrated in FIG. 5 has been described as being performed by the digital camera 101. However, in terms of the terminal that starts the processing of FIG. 5 and the timing thereof, a variety of circumstances are conceivable. For example, if a terminal newly participating in a network gathers device information concerning another terminal already participating in the network and adjusts its own CWmax, it can transmit the annunciation signal at the optimum rate from the moment of participation in the network. Further, a case where a terminal whose remaining battery capacity has fallen below a prescribed value starts the operation of FIG. 5 is also conceivable. Further, the terminal that first constructs an ad-hoc network or a terminal whose CWmax is changeable may transmit a device-information inquiry periodically (501 in FIG. 5).

### Second Embodiment

The first embodiment has been described with regard to an example in which device information is gathered from other terminals that form an ad-hoc network and CWmax of one's own terminal is changed based upon the results of information gathering. A second embodiment will be described with regard to an example of processing whereby another terminal is requested to change CWmax based upon gathered device information.

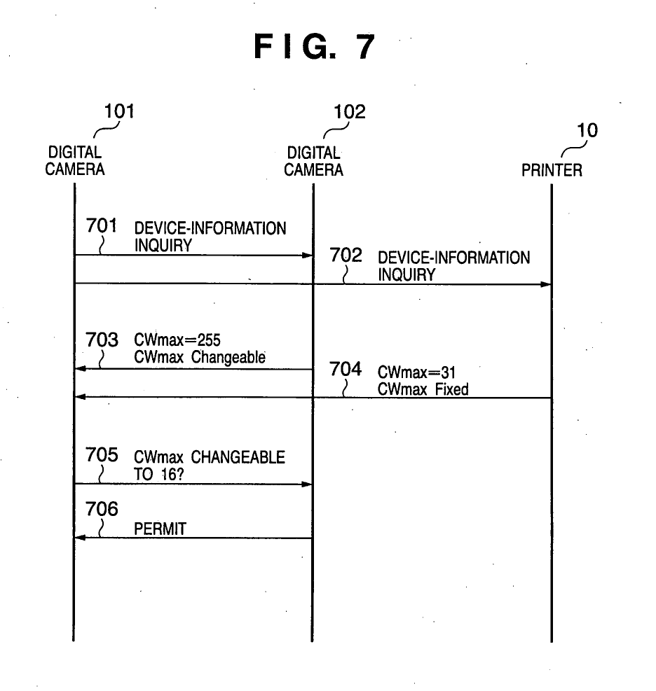

FIG. 7 illustrates a processing sequence according to this embodiment.

The digital camera 101 queries the digital camera 102 and printer 103 for device information (701, 702). Although the respective messages are transmitted by unicast in FIG. 7, unicast is not especially required and transmission may just as well be performed by broadcast or multicast.

It should be noted that device information in this embodiment is assumed to include information as to whether the digital camera 101 is being powered by an AC power source, in addition to information concerning the value of CWmax and information as to whether CWmax is changeable. In a case where the digital camera is powered by battery, it is also possible to include the amount of battery capacity remaining.

In this embodiment, it is assumed that the digital camera 101 and digital camera 102 can change CWmax and that the printer 103 cannot. Further, it is assumed that the digital camera 101 is powered by battery and that the digital camera 102 and printer 103 are powered by AC power sources. Further, it is assumed that the values of CWmax of the digital cameras 101, 102 and printer 103 are 63, 255 and 31, respectively.

Upon receiving the inquiry for device information, the digital camera 102 sends back information to the effect that CWmax is 255, CWmax is changeable and power is being supplied by an AC power source (703). The printer 103 sends back information to the effect that CWmax similarly is 31, CWmax is fixed (unchangeable) and power is being supplied by an AC power source (704).

The digital camera 101 determines whether CWmax of another terminal is to be changed based upon the device information that has been sent back. Here the digital camera 102 transmits the annunciation signal at a low rate (the power consumption of digital camera 102 is low) because CWmax is large. Since power is being supplied from an AC power source, however, sufficient power is being supplied. On the other hand, despite the fact that it is powered by battery, the digital camera 101 has a small CWmax and transmits the annunciation signal at a rate higher than that of the digital camera 102. The power consumption of digital camera 101, therefore, is high.

Accordingly, in order to lower its own power consumption, the digital camera 101 so arranges it that the digital camera 102 will transmit the annunciation signal more. In order to accomplish this, the digital camera 101 requests the digital camera 102 to change CWmax to 16 (705).

Upon receiving the request to change CWmax, the digital camera 102 determines whether to permit the change requested. Here the digital camera 102 sends back to the digital camera 101 the fact that it is permissible to change CWmax to the designated value (706).

By virtue of the foregoing processing, the digital camera 102 sets the CWmax value of 16 in the wireless unit. As a result, the rate of transmission of the annunciation signal from digital camera 102 becomes larger than that of the digital camera 101 and, as a result, the power consumption of the digital camera 101 is reduced.

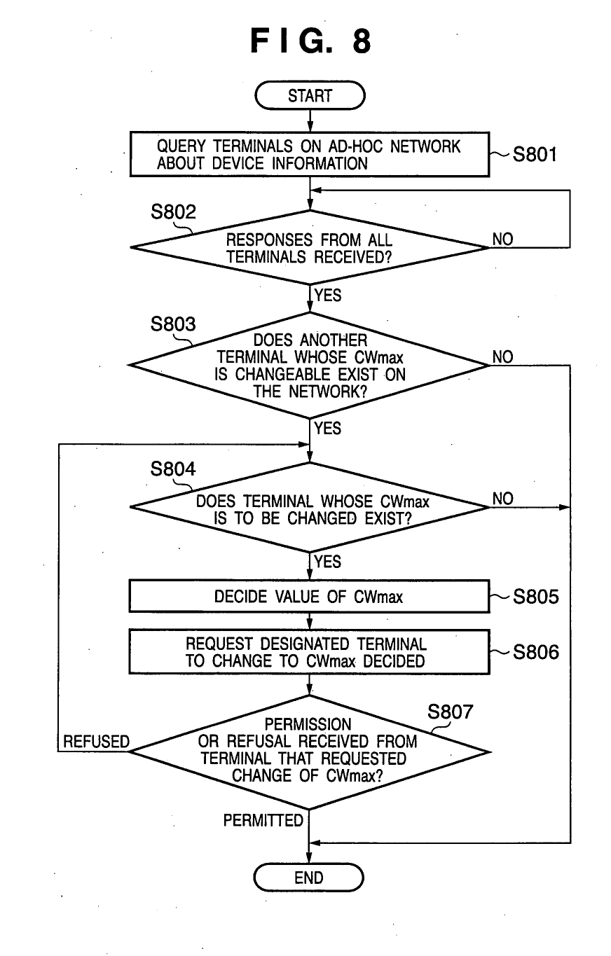

FIG. 8 illustrates the flow of operation of the digital camera 101.

First, the digital camera 101 transmits an inquiry for device information to terminals constituting an ad-hoc network (801). The digital camera 101 waits for responses from all devices on the network (802).

If device information is received from all terminals (“YES” at 802), then the digital camera 101 examines the received information and determines whether other terminals whose CWmax is changeable exist (803).

If terminals whose CWmax is changeable exist (“YES” at 803), the digital camera 101 determines whether there is a terminal among these whose CWmax is to be changed (804). As for criteria for making this determination, conceivable methods include a method of determining to change CWmax in a case where a terminal having the smallest CWmax is powered by battery or in a case where a terminal whose CWmax has been set to be more than twice that of one's own terminal exists.

If a terminal whose CWmax is to be changed exists (“YES” at 804), the digital camera 101 decides what the value of the changed CWmax will be (805) and transmits the request to change CWmax to the relevant terminal (806).

Upon receiving permission for the change from the terminal that transmitted the change request (PERMITTED at 807), the digital camera 101 terminates processing. If refusal of the change is received (REFUSED at 807), control returns to 804. The digital camera 101 determines whether CWmax of the terminal that refused the change is to be changed to a value different from that of CWmax for which change was refused, or whether to change CWmax of another terminal different from the terminal that refused the change.

Further, the digital camera 101 terminates processing in a case where no other terminals whose CWmax is changeable exist (“NO” at 803) or in a case where it is determined that there is no terminal whose CWmax is to be changed even though terminals whose CWmax is changeable exist (“NO” at 804).

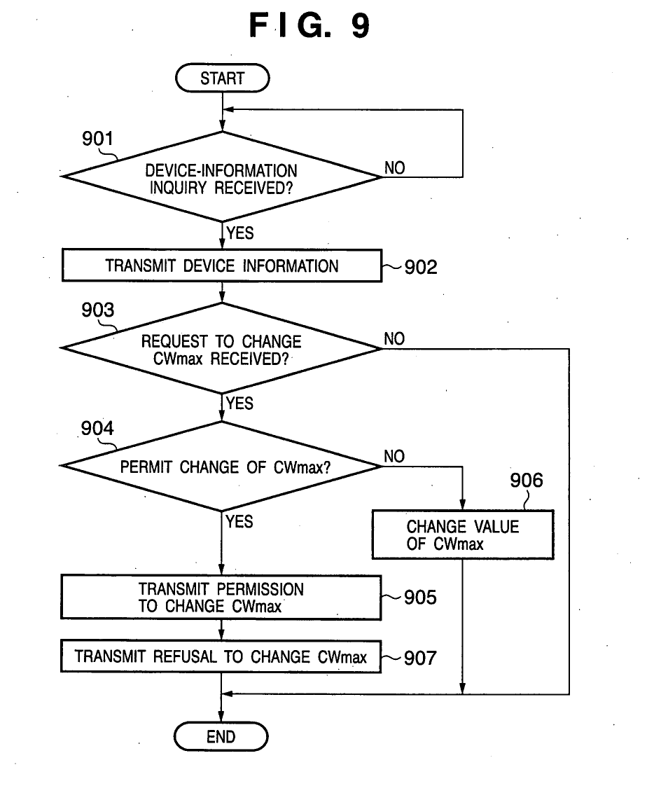

Next, the flow of operation of digital camera 102 and printer 103 will be described with reference to FIG. 9.

First, the digital camera 102 and printer 103 wait for receipt of an inquiry for device information (901). If the inquiry is received (“YES” at 901), the digital camera 102 and printer 103 transmit device information to the source of transmission of the inquiry (902).

If a request to change CWmax is subsequently received (“YES” at 903), then it is determined whether to permit CWmax to be changed to the designated value (904). As for criteria for making this determination, conceivable methods include a method of refusing a change if one's own terminal has changed CWmax even one time, a method of refusing a change if CWmax will become smaller than a prescribed value, and a method of permitting a change if CWmax has been changed one time but will become larger than a prescribed value.

If the change is permitted (“YES” at 904), then permission for the change is transmitted (905) and CWmax is changed to the designated value (907). If the change is not permitted (“NO” at 904), then refusal of the change is transmitted (906) and processing is terminated. If a request to change CWmax is not received (“NO” at 903), then processing is terminated as is.

In accordance with this embodiment, based upon device information acquired from another terminal, control is exercised in such a manner that the other terminal changes CWmax. For example, if one's own terminal has no surplus power, CWmax of a terminal having surplus power is changed to a small value and this terminal is caused to transmit the annunciation signal more, thereby making it possible to reduce the power consumption of one's own terminal. Further, by causing a terminal that does not have surplus power to change CWmax to a large value and thus cause this terminal to lower the rate of transmission of the annunciation signal, power consumption can be reduced. Thus, in accordance with this embodiment, it is possible to take into consideration the device information of other terminals existing on a network and control the transmission of the annunciation signals in such a manner that power consumption will be made appropriate for the system as a whole.

In this embodiment, a terminal that has received a request to change CWmax transmits refusal of the change if the change is refused. However, the refusal need not necessarily be transmitted. If the terminal that has transmitted the change request in such case does not receive permission for the change upon elapse of a prescribed period of time, the terminal judges that the change has been refused. Thus, the same effect can be obtained.

The operation illustrated in FIG. 7 has been described as being performed by the digital camera 101. However, in terms of the terminal that starts the processing of FIG. 7 and the timing thereof, a variety of circumstances are conceivable. For example, if a terminal newly participating in a network gathers device information concerning another terminal already participating in the network and adjusts CWmax of the other terminal, it can transmit the annunciation signal at the optimum rate from the moment of participation in the network. Further, a case where a terminal whose remaining battery capacity has fallen below a prescribed value starts the operation of FIG. 7 is also conceivable. Further, the terminal that first constructs an ad-hoc network or a terminal whose CWmax is changeable may transmit a device-information inquiry periodically.

### Third Embodiment

The first embodiment has been described with regard to an example in which device information is gathered from other terminals that form an ad-hoc network and CWmax of one's own terminal is changed based upon the results of information gathering. The second embodiment has been described with regard to an example in which another terminal is requested to change CWmax based upon the device information gathered. A third embodiment will be described with regard to an example of processing whereby a terminal for which CWmax will be changed is selected, regardless of whether it is one's own terminal or another terminal, based upon the device information gathered, and CWmax of this terminal is then changed.

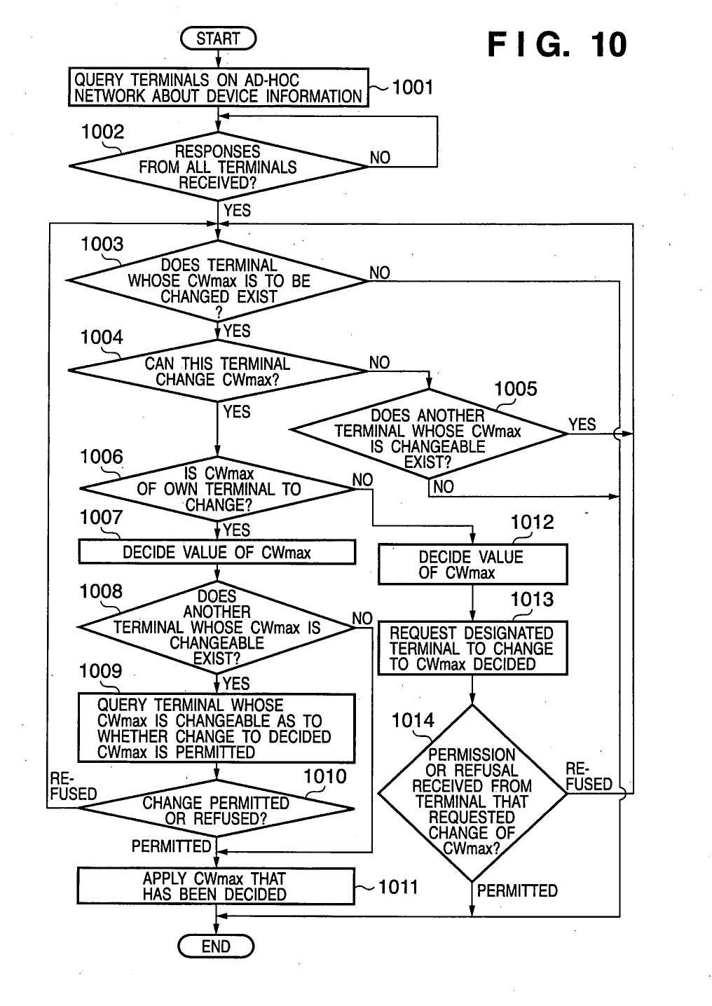

FIG. 10 illustrates the flow of operation of a terminal that starts processing for gathering device information according to this embodiment.

First, terminals constituting the ad-hoc network are queried with regard to device information (1001). As in the second embodiment, the device information is assumed to include information concerning the value of CWmax, information as to whether CWmax is changeable and information as to whether power is being supplied by an AC power source. In a case where power is supplied by battery, it is also possible to include the amount of battery capacity remaining.

The terminal waits until responses are received from all devices on the network (1002).

If device information is received from all terminals (“YES” at 1002), then the received information is examined and it is determined whether a terminal whose CWmax is to be changed exists (1003). If a terminal whose CWmax is to be changed does not exist (“NO” at 1003), processing is terminated.

If a terminal whose CWmax is to be changed exists (“YES” at 1003), then it is determined whether this terminal is one whose CWmax is changeable (1004). If the CWmax is not changeable (“NO” at 1004), then it is determined whether another terminal whose CWmax is changeable exists (1005). If such a terminal exists (“YES” at 1005), then control returns to 1003; otherwise (“NO” at 1005), processing is terminated.

If it is found at 1004 that a terminal whose CWmax is changeable exists (“YES” at 1004), then it is determined whether this terminal whose CWmax is to be changed is one's own terminal (1006). If it is one's own terminal (“YES” at step 1006), then what the value of the changed CWmax will be is decided (1007).

It is determined whether another terminal whose CWmax is changeable exists (1008). If another terminal whose CWmax is changeable exists (“YES” at step 1008), then this terminal is queried as to whether it is permissible to change to the CWmax that has been decided (1009). If permission for the change is received from the queried terminal (PERMITTED at 1010), then the decided value is applied (1011) and processing is terminated. If refusal of the change is received (REFUSED at 1010), control returns to 1003.

If it is found at 1008 that a terminal with a changeable CWmax does not exist (“NO” at 1008), then control returns to 1011 and the decided CWmax is applied.

If it is found at 1006 that the terminal whose CWmax will change is not one's own terminal (“NO” at 1006), then what the value of the changed CWmax will be is decided (1012) and the terminal whose CWmax is to be changed is requested to change CWmax to the value decided (1013). If permission to make the change is received from the terminal that requested the change in CWmax (PERMITTED at 1014), then processing is terminated. If refusal of the change is received (REFUSED at 1014), control returns to 1003.

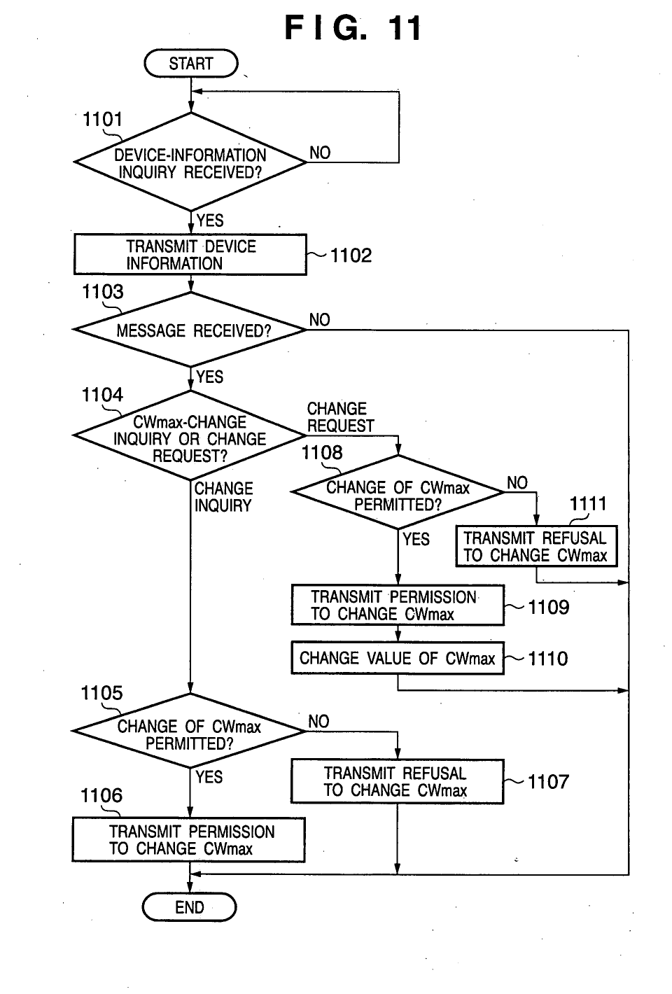

Next, the flow of operation of a terminal that receives a device-information inquiry will be described with reference to FIG. 11.

First, upon receiving the device-information inquiry (“YES” at 1101), the terminal transmits the device information to the source of transmission of the inquiry (1102).

The terminal then stands by for receipt of a message (1103). If no message is received (“NO” at 1103), then the terminal terminates processing. If a message is received (“YES” at 1103), then processing diverges (1104) depending upon whether the message is a CWmax-change inquiry or a CWmax-change request.

If it is determined at 1104 that the message is a CWmax-change inquiry, then the terminal determines whether a change is permitted (1105). In a case where the change is permitted (“YES” at step 1105), then the terminal transmits permission for the change to the terminal that is the source of the inquiry (1106). If the change is not permitted (“NO” at 1105), then the terminal transmits refusal of the change (1107) and terminates processing.

If it is determined at 1104 that the message is a CWmax-change request, then the terminal determines whether a change is permitted (1108). In a case where the change is permitted (“YES” at step 1108), then the terminal transmits permission for the change to the terminal that is the source of the request (1109) and changes CWmax to the designated value (1110). If the change is not permitted (“NO” at 1108), then the terminal transmits refusal of the change to the terminal that is the source of the request (1111) and terminates processing.

In accordance with this embodiment, it is possible to select a terminal for which the rate of transmission of the annunciation signal will be changed, irrespective of whether it is one's own terminal or another terminal, in such a manner that power consumption will be controlled suitably for the network as a whole.

### Fourth Embodiment

In each of the foregoing embodiments, an inquiry is made with regard to CWmax or the capability of a terminal as to whether CWmax is capable of being changed. However, these items of information may be stored beforehand in the flash-ROM 213 or 313 as a program or as data. In particular, in relation to a device for which CWmax is not changeable, as in the case of printer 103 in the foregoing embodiments, it will no longer be necessary to inquire about device information on every occasion. This makes it possible to execute processing efficiently.

### Other Embodiment

It goes without saying that the object of the invention is attained also by supplying a recording medium storing the program codes of the software for performing the functions of the foregoing embodiments to a system or an apparatus, reading the program codes with a computer (e.g., a CPU or MPU) of the system or apparatus from the recording medium, and then executing the program codes. In this case, the program codes per se read from the recording medium implement the novel functions of the embodiments and the recording medium storing the program codes constitutes the invention.

Examples of recording media that can be used for supplying the program code are a flexible disk, hard disk, optical disk, magneto-optical disk, CD-ROM, CD-R, magnetic tape, non-volatile type memory card or ROM, etc.

Furthermore, besides the case where the aforesaid functions according to the embodiments are implemented by executing the program codes read by a computer, it goes without saying that the present invention also covers a case where an operating system or the like running on the computer performs a part of or all of the actual process based upon the designation of program codes and implements the functions according to the embodiments by this processing.

It goes without saying that the present invention further covers a case where, after the program codes read from the recording medium are written to a memory provided on a function expansion board inserted into the computer or to a memory provided in a function expansion unit connected to the computer, a CPU or the like contained in the function expansion board or function expansion unit performs a part of or all of the actual process based upon the designation of program codes and implements the functions of the above embodiments.

Thus, in accordance with the foregoing embodiments, in a system in which communication devices that exist on a network transmit annunciation signals in decentralized fashion, the rate of transmission of the annunciation signal by each communication device is controlled based upon device information from the other communication devices, thereby making it possible to control the power consumption of the communication devices.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-061227, filed on Mar. 7, 2006, which is hereby incorporated by reference herein in its entirety.

What is claimed is:

1. A communication method of a communication device which is connected with other communication devices through a network and separately transmits annunciation signals in conjunction with other communication devices, comprising a control step of controlling a proportion of the annunciation signals transmitted by the communication device and the other communication devices, based upon device information of the other communication devices.

2. The method according to claim 1, further comprising an acquisition step of acquiring the device information of the other communication devices;
wherein said control step controls the proportion of transmission of the annunciation signal based upon device information acquired at said acquisition step.

3. The method according to claim 1, wherein a parameter that decides the frequency of transmission of the annunciation signal of each communication device is set in each communication device; and
the proportion of transmission of the annunciation signal is controlled in accordance with the value of the parameter.

4. The method according to claim 3, further comprising:
a discrimination step of discriminating a communication device for which the parameter will be changed, based upon the device information of the other communication devices; and
a decision step of deciding the value of the parameter that will be set in the communication device discriminated at said discrimination step.

5. The method according to claim 4, further comprising a step of querying the other communication devices in relation to a change to the value of the parameter decided at said decision step;
wherein control of transmission of the annunciation signal is performed based upon a response to the inquiry.

6. The method according to claim 1, wherein the device information includes the value of a parameter that decides the frequency with which the annunciation signal is transmitted by another communication device, and/or information relating to ability to change the parameter.

7. The method according to claim 1, wherein the device information includes status of supply of power.

8. A communication device which is connected with other communication devices through a network and separately transmits annunciation signals in conjunction with the other communication devices, said apparatus comprising a discrimination unit for discriminating a communication device for which frequency of transmission of the annunciation signal be changed, based upon the device information of the other communication devices;
wherein proportion of the annunciation signal transmitted by each communication device is controlled by changing the frequency of transmission of the annunciation signal transmitted by the communication device discriminated by said discrimination unit.

9. A communication system for making communication devices on a network separately transmit annunciation signals, said system comprising a control unit for controlling proportion of transmission of the annunciation signals of each communication device based upon device information of at least two communication devices.

10. A computer program for causing a computer to execute a communication method of a communication device which is connected with other communication devices through a network and separately transmits annunciation signals in conjunction with other communication devices, comprising a control step of controlling a proportion of the annunciation signal that the communication device and the other communication devices based upon device information of the other communication devices.
